(19) United States
(12) Patent Application Publication
(10) Pub. No.: US 2005/0227563 A1
(43) Pub. Date: Oct. 13, 2005

(54) Shaped fiber fabrics

(76) Inventor: Eric Bryan Bond, Maineville, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/144,175

(22) Filed: Jun. 3, 2005

Related U.S. Application Data
(63) Continuation-in-part of application No. 11/047,346, filed on Jan. 28, 2005.
(60) Provisional application No. 60/540,420, filed on Jan. 30, 2004.

(51) Int. Cl. B32B 1/00; D04H 3/00; D04H 1/56; D04H 3/16

(52) U.S. Cl. 442/334; 442/401; 442/400; 442/335; 442/337; 442/338; 442/415; 442/381

(57) ABSTRACT

The present invention relates to a fibrous fabric comprising at least one layer comprising a mixture of shaped fibers having two or more different cross sections. The variety of cross sections include solid round fibers, hollow round fibers, multi-lobal solid fibers, hollow multi-lobal fibers, crescent shaped fibers, square shaped fibers, crescent shaped fibers, and any combination thereof.

### CROSS-REFERENCE TO RELATED APPLICATIONS

This application is a continuation-in-part of U.S. application Ser. No. 11/047,346, filed Jan. 28, 2005, which claims the benefit of U.S. Provisional Application No. 60/540,420, filed Jan. 30, 2004.

### FIELD OF THE INVENTION

The present invention relates to fibrous fabrics comprising a mixture of shaped fibers.

### BACKGROUND OF THE INVENTION

Commercial woven and nonwoven fabrics are typically comprised of synthetic polymers formed into fibers. These fabrics are typically produced with solid fibers that have a high inherent overall density, typically in the range of from about 0.9 g/cm³ to about 1.4 g/cm³. The overall weight or basis weight of the fabric is often dictated by a desired opacity and a set of mechanical properties of the fabric to promote an acceptable thickness, strength, and protection perception.

One reason for the increased usage of polyolefinic polymers, mainly polypropylene and polyethylene, is that their bulk density is significantly lower than polyester, polyamide and regenerated cellulose fiber. Polypropylene density is around about 0.9 g/cm³, while the regenerated cellulose and polyester density values can be higher than about 1.35 g/cm³. The lower bulk density means that at equivalent basis weight and fiber diameter, more fibers are available to promote a thickness, strength and protection perception for the lower density polypropylene.

Another method of addressing consumer acceptance by increasing the opacity of a fabric is by reducing the overall fiber diameter or denier. In fabrics, the spread of “microfiber” technology for improved softness and strength has become fashionable. Other ways to improve opacity and strength while reducing basis weight and cost at the same time is desired.

### SUMMARY OF THE INVENTION

The present invention relates to mixtures of various shaped fibers to provide controllable improvements in opacity, barrier properties, and mechanical properties. The present invention also relates to a spunmelt fibrous fabric comprising at least one layer comprising a mixture of shaped fibers having cross-sectional shapes that are distinct from one another. The variety of cross-sectional shapes is limitless and includes solid round fibers, hollow round fibers, multi-lobal solid fibers, hollow multi-lobal fibers, crescent shaped fibers, square shaped fibers, crescent shaped fibers, and any combination thereof. The two or more different shaped fibers may also have two different fiber diameters. In one embodiment, at least one of the shaped fibers will have a spunlaid diameter. In other embodiments, at least two or all of the shaped fibers will have a spunlaid diameter. In other embodiments, at least one of the shaped fibers will have a meltblown diameter.

The fibrous fabrics of the present invention may be comprised of a single polymer or may be comprised of more than one polymer. Each shaped fiber may be comprised of a different polymer. One or more of the shaped fibers may be a bicomponent or multicomponent fiber. The ratio of fibers of one shape to fibers of another shape can be adjusted to target a specific opacity in combination with specific mechanical properties. Each of the two or more different shaped fibers will typically comprise at least about 5% by weight of the total fibers. The ratio of one shaped fiber to anther may be about 5:95, 10:90, 25:75, or 50:50 or any suitable ratio depending upon desired properties. Typically, the basis weight of the shaped fiber layer of the fibrous fabric will be from about 3 gsm to about 150 gsm.

Preferably, the fibrous fabric comprising the shaped fibers of the present invention will have an opacity higher than a fibrous fabric containing substantially all solid round fibers and produced with the same polymeric material, having fibers with an equivalent fiber denier, and with the same basis weight as the fibrous fabric comprising the shaped fibers. The fibrous fabrics of the present invention comprising shaped fibers may also have an opacity greater than a higher basis weight fibrous fabric containing the same material and substantially all solid round fibers having an equivalent fiber denier and/or the same number of fibers. It is also preferred that the fibrous fabric comprising the shaped fibers of the present invention have an MD-to-CD ratio lower than a fibrous fabric containing substantially all trilobal (non-round) fibers and produced with the same polymeric material, having fibers with an equivalent fiber denier, and with the same basis weight as the fibrous fabric containing the shaped fibers. Additionally, the fibrous fabric with a mixture of shaped fibers may have CD strength and total (MD+CD) strength that is greater than the substantially all trilobal fibers. The apparent bulk density of the fibrous fabrics of the present invention and comprising shaped fibers may be from about 2% to about 50% lower than the bulk density of a fibrous fabric containing substantially all solid round fibers with the same fiber denier, basis weight, and polymer composition.

The present invention also relates to nonwoven laminates. The laminate will comprise at least one first layer comprising a mixture of shaped fibers having cross-sectional shapes that are distinct from one another and at least one second layer comprising different fibers. (Different fibers is defined as meaning that the fibers in the second layer are not identical in cross-sectional shape and ratio to the fibers in the first layer. For example, the fibers may be of the same cross-sectional shapes but in a different ratio. In another example, the fibers may only have one cross-sectional shape or the fibers may be of the same cross-sectional shapes but be of different sizes.) The second layer may be a spunmelt such as meltblown layer or spunlaid layer, a nanofiber layer, carded layer, wetlaid layer cellulosic layer, or any combination thereof. The second layer may also be a film or any other suitable material depending upon the final use of the product. The fibers in the second layer may be round or shaped as long as they fibers of the second layer are not identical in cross-sectional shape, size, and ratio to the fibers of the first layer. In one embodiment of the nonwoven laminate, a first layer containing shaped fibers of the present invention will be laminated on both sides of a meltblown layer. If the first layer contains shaped fibers having spunlaid size diameters, this laminate is commonly referred to as a spunlaid-meltblown-spunlaid laminate (SMS).

The present invention also relates to disposable nonwoven articles. The articles may comprise a fibrous fabric comprising at least one layer comprising a mixture of shaped fibers having cross-sectional shapes that are distinct from one another. Suitable articles include diaper, a catamenial, and a wipe. When the article is a diaper, the fibrous fabric may be utilized as a topsheet, backsheet, outer cover, leg cuff, ear, side panel covering, or any combinations thereof.

### BRIEF DESCRIPTION OF THE DRAWINGS

These and other features, aspects and advantages of the present invention will become better understood with regard to the following description, appended claims, and accompanying drawing where:

FIG. 1 illustrates a round hollow fiber with a shaped hollow core.

FIG. 2 illustrates a round hollow fiber which has a round hollow core.

FIG. 3 illustrates several shaped fibers.

FIG. 4 illustrates several shaped hollow fibers

FIG. 5 illustrates a 90/10 by number trilobal and solid round spinneret with a single sided quench.

FIG. 6 illustrates a 50/50 by number trilobal and solid round spinneret with a double sided quench.

FIG. 7 illustrates a distribution metering plate that feeds each individual capillary orifice.

FIG. 8 illustrates a single melt pump supplying polymer to all metering plates.

FIG. 9 illustrates a two pump system for supplying and regulating the polymer flow to each orifice type located in the metering plate.

FIG. 10 illustrates a single melt pump extrusion system.

### DETAILED DESCRIPTION OF THE INVENTION

All percentages, ratios and proportions used herein are by weight percent of the composition, unless otherwise specified. Examples in the present application are listed in parts of the total composition.

The specification contains a detailed description of (1) materials of the present invention, (2) configuration of the fibers, (3) distribution of fiber mixtures, (4) material properties of the fibers, (5) processes, and (6) articles.

(1) Materials

Thermoplastic polymeric and non-thermoplastic polymeric materials may be used in the present invention. The thermoplastic polymeric material must have Theological characteristics suitable for melt spinning. The molecular weight of the polymer must be sufficient to enable entanglement between polymer molecules and yet low enough to be melt spinnable. For melt spinning, thermoplastic polymers having molecular weights below about 1,000,000 g/mol, preferably from about 5,000 g/mol to about 750,000 g/mol, more preferably from about 10,000 g/mol to about 500,000 g/mol and even more preferably from about 50,000 g/mol to about 400,000 g/mol.

The thermoplastic polymeric materials must be able to solidify relatively rapidly, preferably under extensional flow, and form a thermally stable fiber structure, as typically encountered in known processes such as a spin draw process for staple fibers or a spunbond continuous fiber process. Preferred polymeric materials include, but are not limited to, polypropylene and polypropylene copolymers, polyethylene and polyethylene copolymers, polyester, polyamide, polyimide, polylactic acid, polyhydroxyalkanoate, polyvinyl alcohol, ethylene vinyl alcohol, polyacrylates, and copolymers thereof and mixtures thereof. Other suitable polymeric materials include thermoplastic starch compositions as described in detail in U.S. publications 2003/0109605A1 and 2003/0091803. Other suitable polymeric materials include ethylene acrylic acid, polyolefin carboxylic acid copolymers, and combinations thereof.

The shaped fibers of the present invention may be comprised of a non-thermoplastic polymeric material. Examples of non-thermoplastic polymeric materials include, but are not limited to, viscose rayon, lyocell, cotton, wood pulp, regenerated cellulose, and mixtures thereof. The non-thermoplastic polymeric material may be produced via solution or solvent spinning. The regenerated cellulose is produced by extrusion through capillaries into an acid coagulation bath.

Depending upon the specific polymer used, the process, and the final use of the fiber, more than one polymer may be desired. The polymers of the present invention are present in an amount to improve the mechanical properties of the fiber, improve the processability of the melt, and improve attenuation of the fiber. The selection and amount of the polymer will also determine if the fiber is thermally bondable and affect the softness and texture of the final product. The fibers of the present invention may be comprised of a single polymer, a blend of polymers, or be multicomponent fibers comprised of more than one polymer.

Multiconstituent blends may be desired. For example, blends of polyethylene and polypropylene (referred to hereafter as polymer alloys) can be mixed and spun using this technique. Another example would be blends of polyesters with different viscosities or termonomer content. Multicomponent fibers can also be produced that contain differentiable chemical species in each component. Non-limiting examples would include a mixture of 25 melt flow rate (MFR) polypropylene with 50MFR polypropylene and 25MFR homopolymer polypropylene with 25MFR copolymer of polypropylene with ethylene as a comonomer.

Optionally, other ingredients may be incorporated into the spinnable composition. The optional materials may be used to modify the processability and/or to modify physical properties such as opacity, elasticity, tensile strength, wet strength, and modulus of the final product. Other benefits include, but are not limited to, stability, including oxidative stability, brightness, color, flexibility, resiliency, workability, processing aids, viscosity modifiers, and odor control. Examples of optional materials include, but are not limited to, titanium dioxide, calcium carbonate, colored pigments, and combinations thereof. Further additives including, but not limited to, inorganic fillers such as the oxides of magnesium, aluminum, silicon, and titanium may be added as inexpensive fillers or processing aides. Other suitable inorganic materials include, but are not limited to, hydrous magnesium silicate, titanium dioxide, calcium carbonate, clay, chalk, boron nitride, limestone, diatomaceous earth, mica glass quartz, and ceramics. Additionally, inorganic salts, including, but not limited to, alkali metal salts, alkaline earth metal salts and phosphate salts may be used.

(2) Configuration

The fiber shapes in the present invention may consist of solid round, hollow round and various multi-lobal shaped fibers, among other shapes. A mixture of shaped fibers having cross-sectional shapes that are distinct from one another is defined to be at least two fibers having cross-sectional shapes that are different enough to be distinguished when examining a cross-sectional view with a scanning electron microscope. For example, two fibers could be trilobal shape but one trilobal having long legs and the other trilobal having short legs. Although not preferred, the shaped fibers could be distinct if one fiber is hollow and another solid even if the overall cross-sectional shape is the same.

The multi-lobal shaped fibers may be solid or hollow. The multi-lobal fibers are defined as having more than one critical point along the outer surface of the fiber. A critical point is defined as being a change in the absolute value of the slope of a line drawn perpendicular to the surface of fiber when the fiber is cut perpendicular to the fiber axis. Shaped fibers also include crescent shaped, oval shaped, square shaped, diamond shaped, or other suitable shapes.

Solid round fibers have been known to the synthetic fiber industry for many years. These fibers have a substantially optically continuous distribution of matter across the width of the fiber cross section. These fibers may contain microvoids or internal fibrillation but are recognized as being substantially continuous. There are no critical points for the exterior surface of solid round fibers.

The hollow fibers of the present invention, either round or multi-lobal shaped, will have a hollow region. A solid region of the hollow fiber surrounds the hollow region. The perimeter of the hollow region is also the inside perimeter of the solid region. The hollow region may be the same shape as the hollow fiber or the shape of the hollow region can be non-circular or non-concentric. There may be more than one hollow region in a fiber.

The hollow region is defined as the part of the fiber that does not contain any material. It may also be described as the void area or empty space. The hollow region will comprise from about 2% to about 60% of the fiber. Preferably, the hollow region will comprise from about 5% to about 40% of the fiber. More preferably, the hollow region comprises from about 5% to about 30% of the fiber and most preferably from about 10% to about 30% of the fiber. The percentages are given for a cross sectional region of the hollow fiber (i.e. two dimensional). If described in three dimensional terms, the percent void volume of the fiber will be equivalent to the percent of hollow region.

The percent of hollow region must be controlled for the present invention. The percent hollow is preferably not below 2% or the benefit of the hollow region is not significant. However, the hollow region must not be greater than 60% or the fiber may collapse. The desired percent hollow depends upon the materials used, the end use of the fiber, and other fiber characteristics and uses.

The fiber “diameter” of the shaped fiber of the present invention is defined as the circumscribed diameter of the outer perimeter of the fiber. For a hollow fiber, the diameter is not of the hollow region but of the outer edge of the solid region. For a non-round fiber, fibers diameters are measured using a circle circumscribed around the outermost points of the lobes or edges of the non-round fiber. This circumscribed circle diameter may be referred to as that fiber's effective diameter. Preferably, the fiber will have a diameter of less than 200 micrometers. More preferably the fiber diameter will be from about 3 micrometers to about 100 micrometers and preferably from about 3 micrometer to about 50 micrometers. Fiber diameter is controlled by factors including, but not limited to, spinning speed, mass throughput, temperature, spinneret geometry, and blend composition. The term spunlaid diameter refers to fibers having a diameter greater than about 12.5 micrometers. This is determined from a denier of greater than about 1.0 dpf. The basis for using denier in this invention is polypropylene. A polypropylene fiber that is solid round with a density of about 0.900 g/cm3 has a diameter of 12.55 micrometers. Spunlaid diameters are typically from about 12.5 to about 200 microns and preferably from about 12.5 to about 150 microns. Meltblown diameters are smaller than spunlaid diameters. Typically, meltblown diameters are from about 0.5 to about 12.5 micrometers. Preferable meltblown diameters range from about 1 to about 10 micrometers.

The average fiber diameter of two or more shaped fibers having cross-sectional shapes that are distinct from on another is calculated by measuring each fiber type's average diameter, adding the average diameters together, and dividing by the total number of fiber types (different shaped fibers). The average fiber denier is also calculated by measuring each fiber type's average denier, adding the average deniers together, and dividing by the total number of fiber types (different shaped fibers). A fiber is considered having a different diameter or denier if the average diameter is at least about 10% higher or lower. The two or more shaped fibers having cross-sectional shapes that are distinct from one another may have the same diameter or different diameters. Additionally, the shaped fibers may have the same denier or different denier. In some embodiments, the shaped fibers will have different diameters and the same denier.

The shaped fibers of the present invention will have a lower overall apparent bulk density. The apparent bulk density is less than the actual density of the same polymeric composition used for of a solid round fiber with the same circumscribed diameter. The apparent bulk density will be from about 2% to about 50% and preferably from about 5% to about 35% less than the actual density. Apparent bulk density, as used herein, is defined as the density of a shaped fiber with a circular circumscribed diameter as if it were a solid round fiber. The apparent bulk density is less because the mass of the fiber is reduced while the circumscribed volume remains constant. The mass is proportional to the area. For example, the apparent bulk density of a tribal fiber is the circumscribed area of the shaped fiber. Therefore, the apparent bulk density is calculated by measuring the total solid area compared to the total circumscribed area. Similarly, the apparent bulk density of a hollow round fiber is measured by the total circumscribed area of the fiber minus the area of the hollow region. The apparent bulk density of the collection of shaped fibers in a layer can also be calculated.

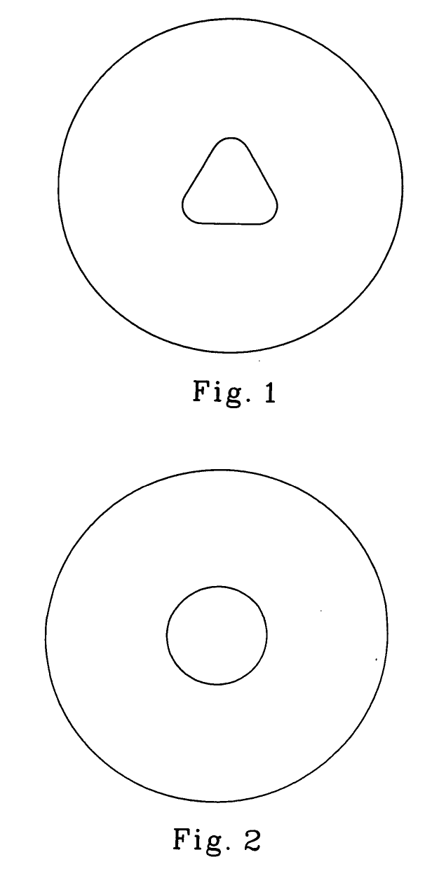

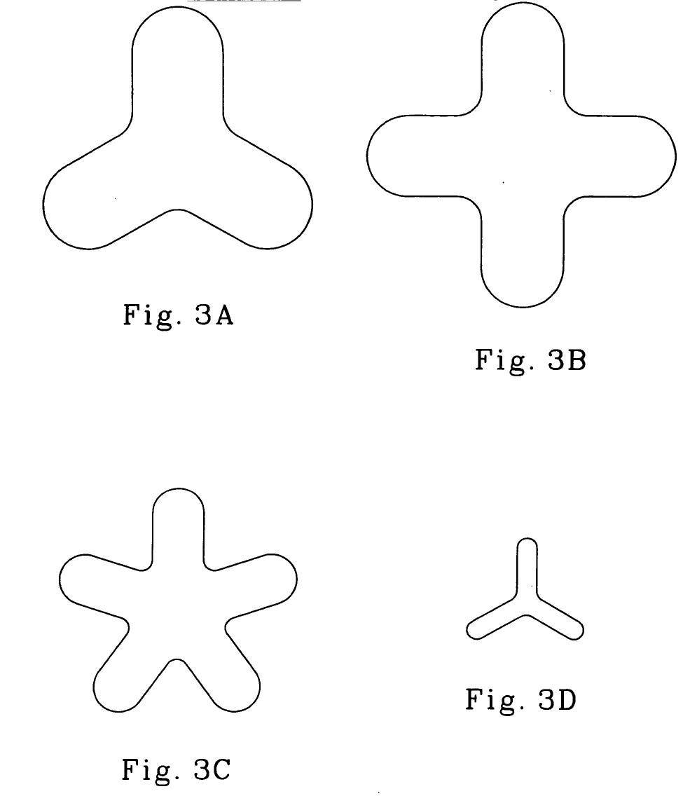

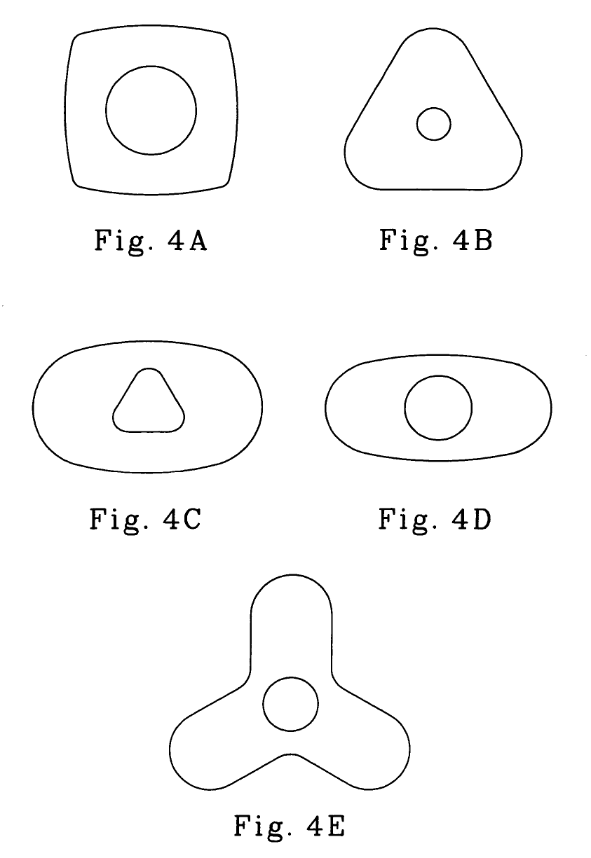

FIG. 1 illustrates a round hollow fiber. The shape of the hollow region of this fiber is not round. FIG. 2 is used to illustrate a round hollow fiber. As shown, the center of the hollow region and the center of the hollow fiber are the same. Additionally, the shape or curvature of the perimeter of the hollow region and the hollow fiber are the same. FIG. 3 illustrates several different shapes of the fibers including various trilobal and multi-lobal shapes. FIG. 4 illustrates shaped hollow fiber.

Multi-lobal fibers include, but are not limited to, the most commonly encountered versions such as trilobal and delta shaped. Other suitable shapes of multi-lobal fibers include triangular, square, star, or elliptical. These fibers are most accurately described as having at least one critical point. Multilobal fibers in the present invention will generally have less than about 50 critical points, and most preferably less than about 20 critical points. The multi-lobal fibers can generally be described as non-circular, and may be either solid or hollow.

The mono and multiconstituent fibers of the present invention may be in many different configurations. Constituent, as used herein, is defined as meaning the chemical species of matter or the material. Fibers may be of monocomponent in configuration. Component, as used herein, is defined as a separate part of the fiber that has a spatial relationship to another part of the fiber.

The fibers of the present invention may be multicomponent fibers. Multicomponent fibers, commonly a bicomponent fiber, may be in a side-by-side, sheath-core, segmented pie, ribbon, or islands-in-the-sea configuration. The sheath may be non-continuous or continuous around the core. If present, a hollow region in the fiber may be singular in number or multiple. The hollow region may be produced by the spinneret design or possibly by dissolving out a water-soluble component, such as PVOH, EVOH and starch, for non-limiting examples.

(3) Distribution of Fiber Mixtures

The fiber shapes in the present invention are mixed together in a single layer to provide a synergistic effect versus the presence of substantially all round fibers alone or substantially all non-round fibers alone. “Substantially all” is defined as having less than about 5% of different shapes and is not intended to exclude layers wherein less than 5% of the fibers are different due to not being able to completely control the process. The mixture of shaped fibers having cross-sectional shapes that are distinct from one another in a single layers is also more beneficial that a nonwoven with discrete layers of fibers having distinct cross-sectional shapes. For example, the fibrous fabric of the present invention may perform differently and be more desired than a nonwoven laminate where one distinct layer has substantially all solid round fibers and another distinct layer has substantially all trilobal fibers. These benefits may be observed in opacity and/or mechanical properties. It is believed that the mixture of shaped fibers in a single layer may be beneficial because the different shapes may prevent roping or other non-uniformity issues during production.

Due to the need to control fabric opacity and mechanical properties, numerous combinations of fibers shapes mixed together are possible. In general, the fiber mixtures will comprise solid round and hollow round, solid round and multi-lobal, hollow round and multi-lobal, and solid round and hollow round and multilobal and combinations thereof.

In order to manifest the additional benefits of fiber mixtures, the minor component of the mixture must be present in sufficient amount to enable differentiation versus 100% of the same shape fiber in a nonwoven web. Therefore, the minor component is present in at least 5% by weight mass of the total fiber composition. Each of the two different shaped fibers can comprise from about 5% by weight to about 95% by weight. The specific percent of each fiber desired depends upon the use of the nonwoven web and specific shape of the fiber.

(4) Material Properties

The fibrous fabrics of the present invention will have a basis weight and opacity that can be measured. Opacity can be measured using TAPPI Test Method T 425 om-01 “Opacity of Paper (15/d geometry, Illuminant A/2 degrees, 89% Reflectance Backing and Paper Backing)”. The opacity is measured as a percentage. The opacity of the fibrous fabric comprising at least one layer comprising a mixture of shaped fibers having cross-sectional shapes that are distinct from one another will be several percentage points of opacity greater than the fibrous fabric containing substantially all round fibers with the same average fiber denier and basis weight and made of the same polymeric material. The opacity may be from about 2 to about 50 percentage points greater and commonly from about 4 to about 30 percentage points greater. Preferably, the opacity will be at least about 5% greater, more preferably 7% greater, and most preferably about 10% greater. For example, it is preferred that a mixture of 75% trilobal fibers and 25% solid round fibers and a mixture of 50% trilobal fibers and 50% solid round fibers both have higher opacity measurements at equivalent basis weights than 100% hollow round fibers and 100% solid round fibers.

Basis weight is the mass per unit area of the substrate. Independent measurements of the mass and area of a specimen substrate are taken and calculation of the ratio of mass per unit area is made. Preferably, the basis weight of the layer comprising a mixture of shaped fibers having cross-sectional shapes that are distinct from one another will be from about 1 grams per square meter (gsm) to about 150 gsm depending upon the use of the fibrous fabric. More preferable basis weights are from about 2 gsm to about 30 gsm and from about 4 gsm to about 20 gsm. The basis weight of the total fibrous fabric (including the layer comprising a mixture of shaped fibers) is from about 4 gsm to about 500 gsm, preferably from about 4 gsm to about 250 gsm, and more preferably from about 5 gsm to about 100 gsm.

Additionally, the fibrous fabrics produced from the shaped fibers will also exhibit certain mechanical properties, particularly, strength, flexibility, elasticity, extensibility, softness, thickness, and absorbency. Measures of strength include dry and/or wet tensile strength. Flexibility is related to stiffness and can attribute to softness. Softness is generally described as a physiologically perceived attribute that is related to both flexibility and texture. Absorbency relates to the products' ability to take up fluids as well as the capacity to retain them. The fibrous fabrics of the present invention will also have desirable barrier properties.

Preferably, the fibrous fabric comprising at least one layer comprising a mixture of shaped fibers having cross-sectional shapes that are distinct from one another will have a machine direction to cross-machine direction ratio (MD-to-CD ratio) lower than a fibrous fabric produced with substantially all trilobal cross-sectional fibers having the same polymeric material, equivalent fiber denier, and basis weight. Additionally, it is desired that the fibrous fabric of the present invention will also have a CD strength and/or total (MD+CD) strength that is greater than the fibrous fabric with substantially all trilobal cross-sectional fibers. Having the MD-to-CD ratio lower than a substantially all trilobal layer can be desired as the CD strength of the trilobal layers is not as high as desired and the MD strength may be too high. It is desired to have a relatively high CD strength in a layer so that the basis weight does not need to be increased to achieve the relatively high CD strength. The relatively high CD strength is desired in some application for keeping the tabs and/or fasteners attached in an absorbent article. If the MD strength is too high (or the basis weight must be increased to increase the CD strength creating a very high MD strength), issues in the converting process may occur. Therefore, to get the best performance, it is desired to control the MD-to-CD strength ratio and keep a high total strength. The MD and CD tensile strengths can be measured by ASTM D1682. For example, it is preferred that a mixture of 75% trilobal fibers and 25% solid round fibers and a mixture of 50% trilobal fibers and 50% solid round fibers both have a lower MD-to-CD ratio than 100% trilobal fibers. For example, it is preferred that a mixture of 75% trilobal fibers and 25% solid round fibers and a mixture of 50% trilobal fibers and 50% solid round fibers both have a higher CD strength at all bonding temperatures than 100% trilobal fibers.

(5) Processes

The fibrous fabric of the present invention is a spunmelt nonwoven fibrous fabric. Spunmelt is defined to mean thermoplastic extrusion. Spunmelt includes spunlaid and meltblown processes. Spunmelt also includes spunbond fabrics.

The first step in producing a fiber is the compounding or mixing step. In the compounding step, the raw materials are heated, typically under shear. The shearing in the presence of heat will result in a homogeneous melt with proper selection of the composition. The melt is then placed in an extruder where the material is mixed and conveyed through capillaries to form fibers. The fibers are then attenuated and collected. The fibers are preferably substantially continuous (i.e. having a length to diameter ratio greater than about 2500:1), and will be referred to as spunlaid fibers. A collection of fibers is combined together using heat, pressure, chemical binder, mechanical entanglement, hydraulic entanglement, and combinations thereof resulting in the formation of a nonwoven fibrous fabric. The fibrous fabric may then be incorporated into an article.

Equipment

An example of the equipment that can be used to produce shaped fibers and fibrous fabrics in the examples is available at Hills Inc. located in Melbourne, Fla. A line used to produce spunlaid shaped fibers and fabrics consists of five main parts: (1) Extruders and melt pumps to melt, mix and meter the polymer component, (2) a spin pack system comprising a polymer melt distribution system and spinneret that delivers a polymer melt(s) to capillaries that have shaped orifices, (3) attenuation device driven by pneumatic air, positive pressure, direct force, or vacuum by which air drag forces act on a polymer stream to attenuate the fiber diameter to smaller than the orifice overall geometric shape, (4) fiber laydown region where fibers are collected underneath the attenuation device in a random orientation (defined by having machine direction and converse direction fiber orientation ratio less than 10), and (5) fiber bonding system that prevents long range collective fiber movement. Numerous companies manufacture fiber and fabric making technologies that can be used for the present invention, non-limiting examples include Hills Inc., Reifenhauser GmbH, Neumag ASON, Reiter, and others.

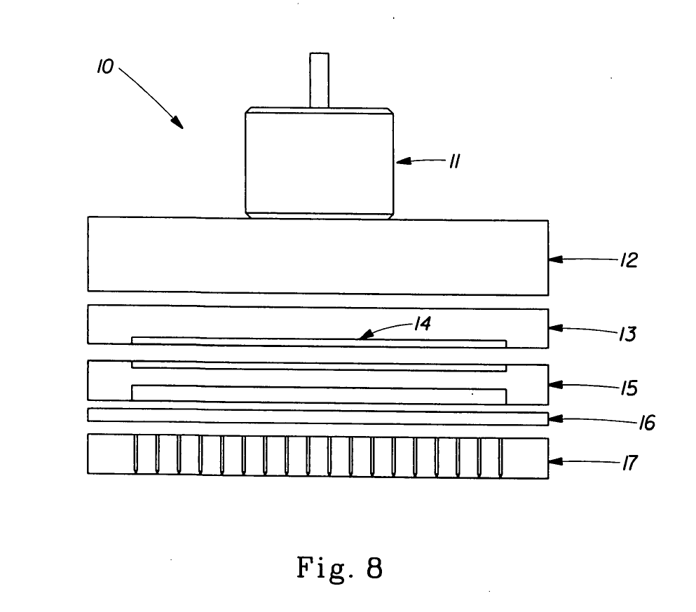

The extruders and melt pumps will be chosen based on the polymers desired. FIG. 8 illustrates a single melt pump extrusion system 10 supplying polymer to all metering plates. This system 10 may be used with a single polymer or a blend of polymers. In FIG. 8, the pump 11, pump block 12, pack top 13, filter 14, and filter support plate 15 are all shown. A metering plate 16 and spinneret 17 complete the system.

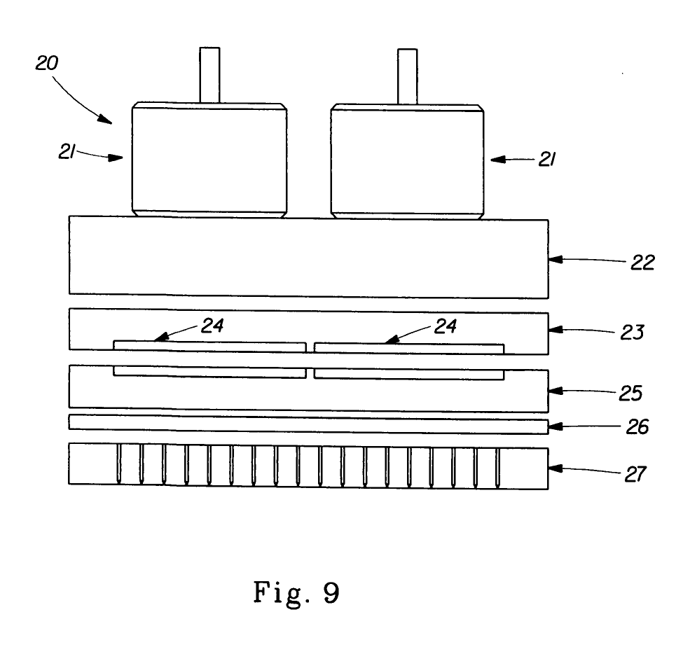

If two types of different polymers are used to spin fibers, it may be desired to have more control by using a two melt pump extrusion system 20 as shown in FIG. 9. This system 20 may have a single extruder or two extruders. The use of two metering or melt pumps 21 is shown in FIG. 9 where one pump 21 is used to feed one type of orifice and the second pump 21 is used to feed the other type of orifice. Similar to the single melt pump extrusion system of FIG. 8, a pump block 22, pack top 23, two filters 24, filter support plate 25, metering plate 26, and spinneret 27 complete the system. Each of the two pumps 21 may supply the same polymer, the same polymer with different additives (such as titanium dioxide), or a different polymer blend. The polymer temperatures feed to or from the two pumps 21 may also be adjusted to assist in creating the polymer conditions for producing the best cross sections and the desired shear rates for the fibers.

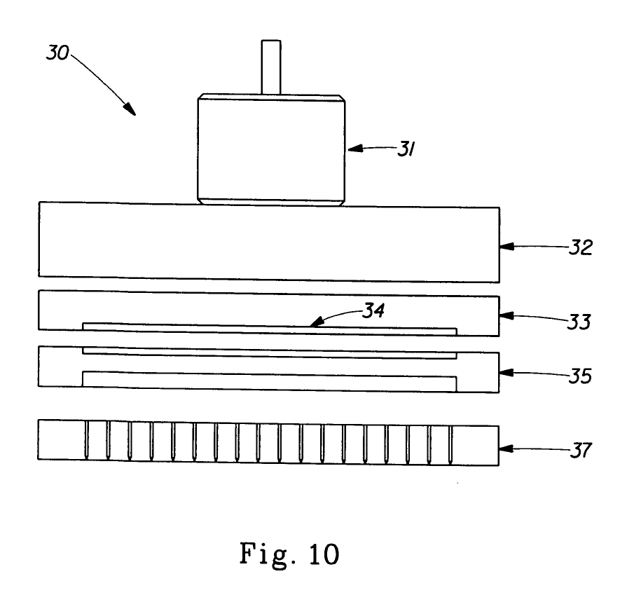

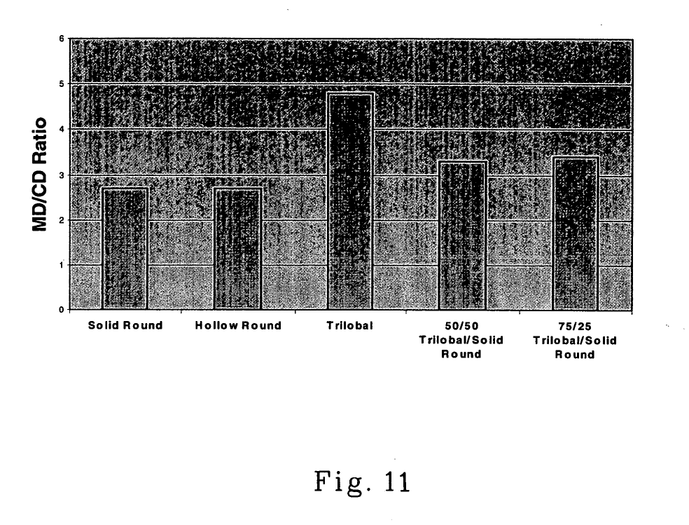

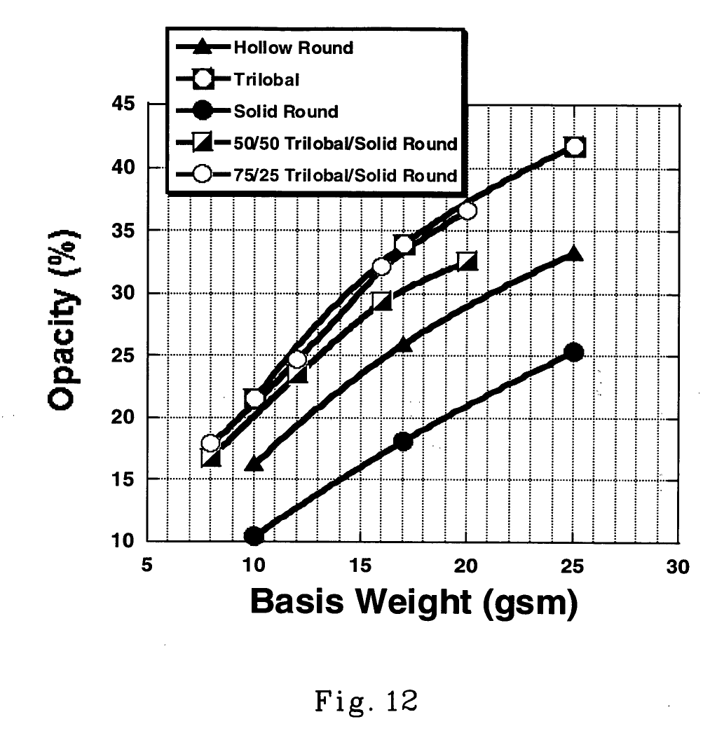

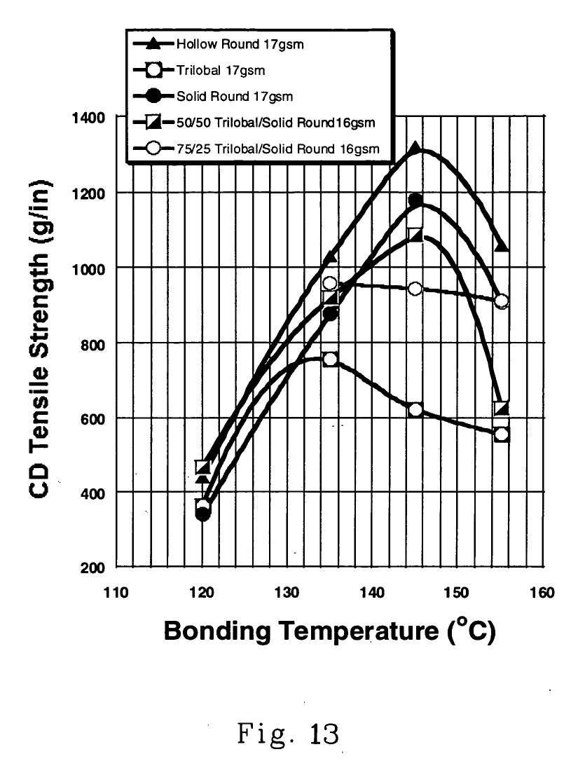

FIG. 10 also illustrates a single melt pump extrusion system. This system 30, which may also be used with a single polymer or a blend of polymers, is similar to the single melt pump system is FIG. 8 except for the metering plate is not included. In FIG. 10, the pump 31, pump block 32, pack top 33, filter 34, and filter support plate 35 are all shown with a spinneret 37.

The polymer melt may be distributed through the use of a distribution or metering plate. The metering plate may be used to distribute polymer from a filtration area to two or more types of spin holes placed across the spinneret. The metering plate can be used to help obtain the desired values of pressure drop and sheer rate to produce the desired diameter or denier from a single pressured pool of polymer. Channels in the plate may deliver the polymer to the back side of selected spinneret orifices (the distribution function of the plate), and by selected polymer pressure drop, the channels selectively deliver the desired amount of polymer to the back side of each spinneret orifice (the metering function of the plate).

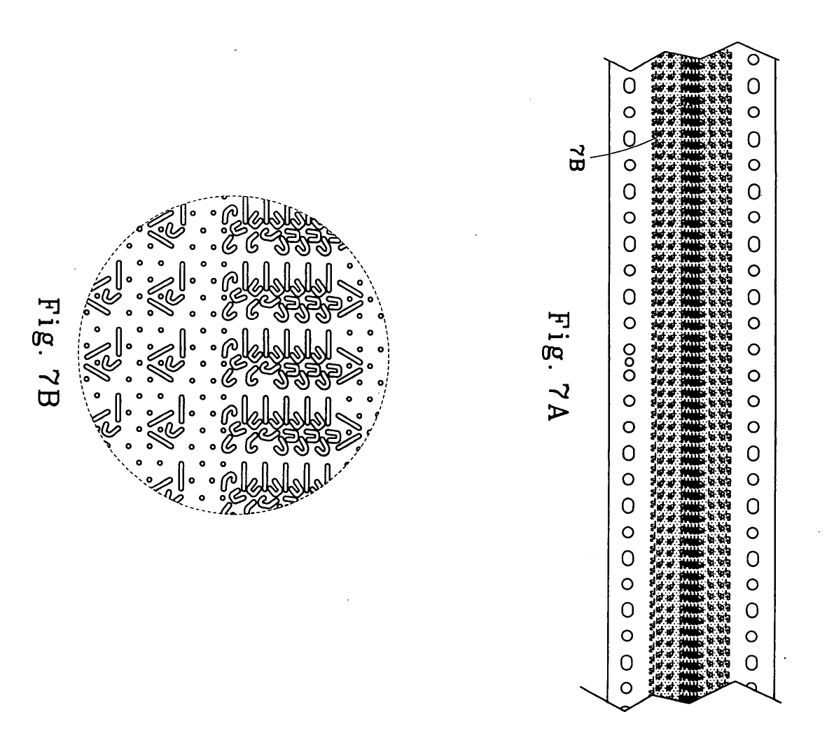

FIG. 7 shows typical etched designs that can be used for distribution, metering, and valve plates. Etched metering plates as shown in FIG. 7 provide flexible distribution capabilities and can be produced economically. Alternatively, a drilled metering can be used. A drilled metering plate will typically have significant thickness which requires that hole length becomes a part of the pressure drop calculations. Therefore, different diameter holes can be used to control and adjust the flow rate through the drilled metering plate/spinneret combination to adjust the deniers of the two types of fibers being spun from the same melt pool. By using different metering plates, different denier ratios between the two types of spin holes can be obtained without requiring a new spinneret. A metering plate can be used for multipolymer systems and can also be used for single polymer systems. Typically, there was not a need for a metering plate for a single polymer system. However, with the different shaped orifices, a metering plate can provide enhanced flexibility in controlling denier and diameter of the resulting fiber through control of the polymer flow to each orifice design. Further examples of suitable metering plates and the low cost etching process are disclosed in U.S. Pat. No. 5,162,074.

A metering plate is not required in the present invention but may be desired to add more control to the system. Other methods of distributing and metering polymer to the spinneret orifices may be used as long as the pressure drop, shear rate and jet stretch are controlled. The jet stretch is the ratio of the maximum spinning velocity of the fibers to the velocity of the polymer at the exit of the spinneret hole.

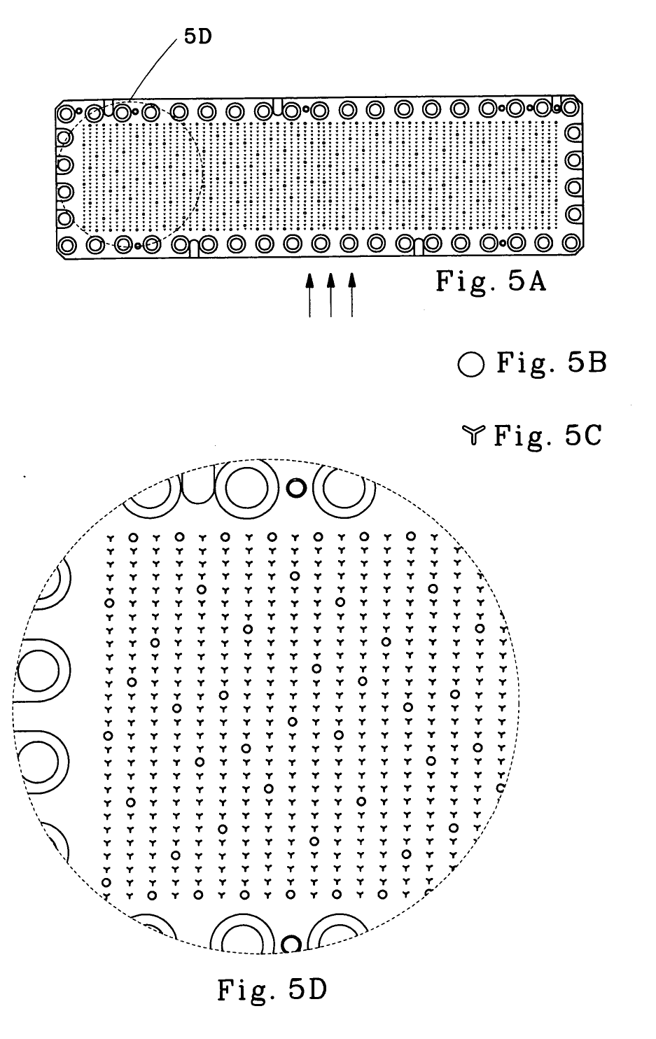

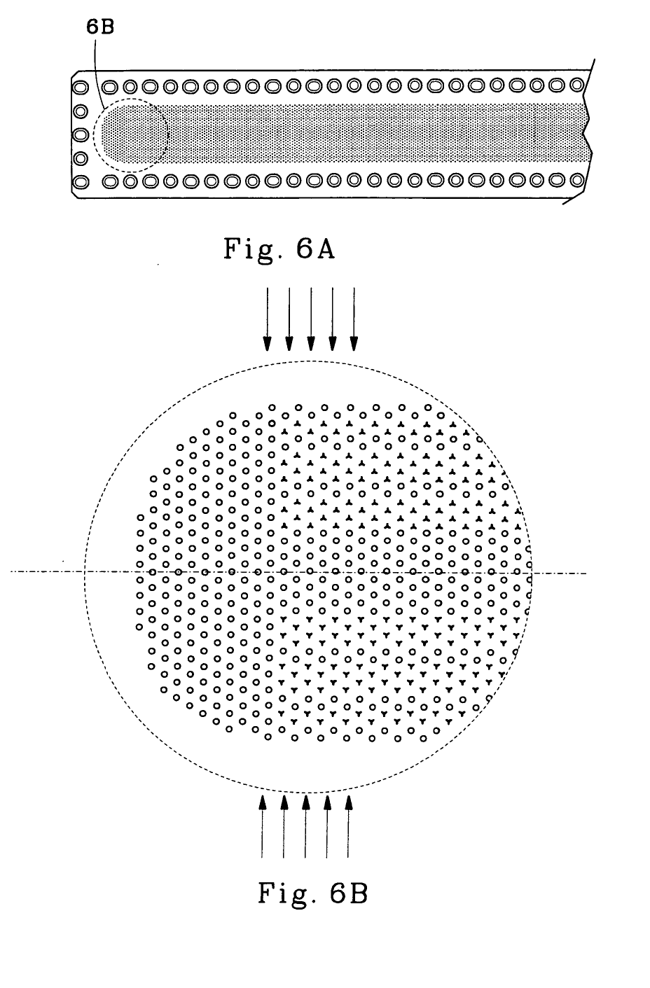

FIGS. 5 and 6 show examples of spinnerets that can be used to make the mixed shaped fibers. These figures show ratios from about 90/10 to about 50/50. The ratio of fibers can range from about 95/5 to about 5/95. The spinnerets may also have more than two different shapes of fibers such as a 25/40/35 ratio of trilobal, solid round, and hollow round.

It may be desired in some examples to control the orientation of the spinneret holes. FIGS. 5A and 5D illustrates a one-sided quench with round fibers (FIG. 5B) and trilobal fibers (FIG. 5C). It may be desired to have the tip of the trilobal fibers (or other multi-lobal fibers) oriented into the quench flow as shown in FIG. 5. This orientation may allow the quench air to contact the majority of all lobes, resulting in the most uniform quenching and physical properties for the fiber. This orientation also prevents the quench air from rotating the trilobal fibers which would cause turbulence and fiber to fiber collisions in the spinning process. A two sided quench, as shown in FIG. 6, is often preferred in spunbond processing. For a two sided quench, it may be preferable to orient the direction of the trilobal fibers in the center of the spinneret so that the tips are oriented toward the closest source of quench air as shown in FIG. 6B. The orientation of the multilobal orifices should be controlled for spinnerets having more than one 2 multilobal orifice per 1 cm².

The location of the shaped fibers within the spinneret may also be controlled. The round holes, which are less costly to manufacture and easier to have good spinning with fewer breaks, may be positioned on the ends of the spinneret. The ends, outside, or middle rows are all where turbulence is greatest and the multilobal fibers may spin and tangle more. Also, the ends are typically where edges are trimmed for recycle or wasted. One example of such an arrangement is shown in FIG. 6B. The shaped fiber orifices can be arranged in hole patterns that are not straight rows of holes or in any suitable arrangement to help minimize turbulence and to maximize quench rate and stable processing. In some executions, it is desired to have random orientation. This may aid in the reduction or roping or other non-uniformity issues.

It may be desired that the flexible spin pack system be retrofitted to existing spunlaid lines. The term spunlaid is used to describe a spinning system that includes the extruder, polymer metering system, spinpack, cooling section, fiber attenuation, fiber laydown and deposition onto a belt or drum and vacuum. The spunlaid system does not denote the type of fiber consolidation. A spunbond line includes a spunlaid line and thermal point bonding. The equipment before the fiber consolidation is identical on a spunbond line or spunlaid line.

In the present invention the fiber mixtures are produced by distributing the various orifice geometries across the spinneret face to produce a relatively uniform fiber distribution of shapes on fiber laydown through their spatial location across the spinneret face. Several examples are shown for illustration although the particular geometries are endless.

Spinning

The present invention utilizes the process of melt spinning in its most preferred embodiment. In melt spinning, there is no intentional mass loss in the extrudate. Solution spinning may be used for producing fibers from cellulose, cellulosic derivatives, starch, and protein.

Spinning will occur at 100° C. to about 350° C. The processing temperature is determined by the chemical nature, molecular weights and concentration of each component. Fiber spinning speeds of greater than 100 meters/minute are required. Preferably, the fiber spinning speed is from about 500 to about 14,000 meters/minute. The spinning may involve direct spinning, using techniques such as spunlaid or meltblown, as long as the fibers are mostly continuous in nature. Continuous fibers are hereby defined as having length to width ratio greater than about 2500:1.

The fibers and fabrics made in the present invention often contain a finish applied after formation to improve performance or tactile properties. These finishes typically are hydrophilic or hydrophobic in nature and are used to improve the performance of articles containing the finish. For example, Goulston Technologies' Lurol 9519 can be used with polypropylene and polyester to impart a semi-durable hydrophilic finish.

(6) Articles

The spunmelt fibrous fabrics of the present invention are nonwoven webs. The fibrous fabric may comprise one or more layers. If the fibrous fabric contains more than one layer, the layers are typically consolidated by thermal point-bonding or other techniques to attain strength, integrity and certain aesthetic characteristics. A layer is part of (or all of) a fibrous fabric that is produced in a separate fiber lay down or forming step and will have the same fibers intimately mixed throughout the layer. A laminate is defined as a two or more nonwoven layers contacting along at least a portion of their respective planar faces with or without interfacial mixing. A fibrous fabric may contain one or more laminates. In a spunlaid or meltblown process, the fibers are consolidated using industry standard spunbond type technologies. Typical bonding methods include, but are not limited to, calender (pressure and heat), thru-air heat, mechanical entanglement, hydraulic entanglement, needle punching, and chemical bonding and/or resin bonding. Thermally bondable fibers are required for the pressurized heat and thru-air heat bonding methods. Fibers may also be woven together to form sheets of fabric. This bonding technique is a method of mechanical interlocking.

The mixture of shaped fibers of the present invention may also be bonded or combined with thermoplastic or non-thermoplastic nonwoven webs or with film webs to make various articles. The polymeric fibers, typically synthetic fibers, or non-thermoplastic polymeric fibers, often natural fibers, may be used in discrete layers. Suitable synthetic fibers include fibers made from polypropylene, polyethylene, polyester, polyacrylates, and copolymers thereof and mixtures thereof. Natural fibers include lyocell and cellulosic fibers and derivatives thereof. Suitable cellulosic fibers include those derived from any tree or vegetation, including hardwood fibers, softwood fibers, hemp, and cotton. Also included are fibers made from processed natural cellulosic resources such as rayon.

The single layer of shaped fibers of the present invention may be utilized by itself in an article, or the layer may be combined with other nonwoven layers or a film layer to produce a laminate. Examples of suitable laminates include, but are not limited to spunbond-meltblown-spunbond laminates. Because of the higher opacity and control over the mechanical properties, a spunbond layer of shaped fibers may have a lower basis weight than a typical spunbond layer made of only solid round fibers, but still provide the same opacity and mechanical properties as the higher basis weight solid round fiber layer. Alternatively, a shaped fiber layer may be utilized which enables the basis weight or denier of the meltblown layer to be reduced or can eliminate the need for a meltblown layer. A spunbond layer of the shaped fibers of the present invention can also be used in a spundbond-nanofiber-spundbond laminate. The shaped fiber layer can be used as both spunbond layers or only as one spunbond layer. Each separate layer in a nonwoven is identified as a layer that is produced with a different composition of fibers. As described in the present invention, a single layer may have a combination of different fiber shapes, diameter, configuration, and compositions. The shaped fiber nonwoven layer may also be combined with a film web. These laminates are useful as backsheet and other barriers on disposable nonwoven articles.

The shaped fibers of the present invention may be used to make nonwovens, among other suitable articles. Nonwoven or fibrous fabric articles are defined as articles that contain greater than 15% of a plurality of fibers that are non-continuous or continuous and physically and/or chemically attached to one another. The nonwoven may be combined with additional nonwovens or films to produce a layered product used either by itself or as a component in a complex combination of other materials, such as a baby diaper or feminine care pad. Preferred articles are disposable, nonwoven articles. The resultant products may find use in filters for air, oil and water; vacuum cleaner filters; furnace filters; face masks; coffee filters, tea or coffee bags; thermal insulation materials and sound insulation materials; nonwovens for one-time use sanitary products such as diapers, feminine pads, and incontinence articles; biodegradable textile fabrics for improved moisture absorption and softness of wear such as micro fiber or breathable fabrics; an electrostatically charged, structured web for collecting and removing dust; reinforcements and webs for hard grades of paper, such as wrapping paper, writing paper, newsprint, corrugated paper board, and webs for tissue grades of paper such as toilet paper, paper towel, napkins and facial tissue; medical uses such as barrier products, surgical drapes, wound dressing, bandages, dermal patches and self-dissolving sutures; and dental uses such as dental floss and toothbrush bristles. The fibrous web may also include odor absorbents, termite repellants, insecticides, rodenticides, and the like, for specific uses. The resultant product absorbs water and oil and may find use in oil or water spill clean-up, or controlled water retention and release for agricultural or horticultural applications. The resultant fibers or fiber webs may also be incorporated into other materials such as saw dust, wood pulp, plastics, and concrete, to form composite materials, which can be used as building materials such as walls, support beams, pressed boards, dry walls and backings, and ceiling tiles; other medical uses such as casts, splints, and tongue depressors; and in fireplace logs for decorative and/or burning purpose. Preferred articles of the present invention include disposable nonwovens for hygiene applications, such as facial cloths or cleansing cloths, and medical applications. Hygiene applications include wipes, such as baby wipes or feminine wipes; diapers, particularly the top sheet, leg cuff, ear, side panel covering, back sheet, dusting layer, acquisition layer, core wrap, core, or outer cover; and feminine pads or products, particularly the top sheet. Other preferred applications are wipes or cloths for hard surface cleansing. The wipes may be wet or dry. While diapers may be assembled in a variety of well know configurations, suitable diaper configurations are described generally in U.S. Pat. Nos. 6,004,306; 5,460,622; 4888,231; and 4,673,402.

### CONTINUOUS FIBER EXAMPLES

The Examples below further illustrate the present invention. A polypropylene was purchased from ATOFINA as FINA 3860X. Two polypropylenes were purchased from Basell, Profax PH-835 and PDC-1274. A polyethylene was purchased from Dow Chemical as Aspun 6811A. Two polyester resins were purchased from Eastman Chemical Company as Eastman F61HC as a PET and Eastman 14285 as a coPET. The meltblown grade resin polypropylene was purchased from Exxon Chemical Company as Exxon 3456G.

The opacity measurements shown are made on an Opacimeter Model BNL-3 Serial Number 7628. Three measurements are made on one specimen with an average of three specimens for each material used.

### Comparative Examples

### 100% Solid Round, Hollow Round or Trilobal

A polypropylene spunbond fabric is produced from Basell PH-835, except for examples C13-15 which are produced from FINA 3860X. C1-C7 and C13-C33 have a through-put per hole of 0.4 ghm. C8-C12 have a through-put per hole of 0.65 ghm. The shape of the fiber is indicated in the table as solid round (SR), hollow round (HR) and trilobal (TRI). All comparative examples are using 2016 hole spinnerets. The fiber are attenuated to an average fiber diameter or denier indicated in the table. These fibers are thermally bonded together using heat and pressure. The following nonwoven fabrics are produced, basis weight determined, and the opacity and/or CD tensile strength of the nonwoven is measured on the samples.

TABLE 1
Comparative Opacity

| | | Basis | Fibrer | Fiber | |
|---|---|---|---|---|---|
| | | Weight | Diameter | Denier | Opacity |
| No. | Shape | (gsm) | (μm) | (dpf) | (%) |
| C1 | SR | 25 | 15.3 | 1.5 | 25.4 |
| C2 | SR | 17 | 15.3 | 1.5 | 18.2 |
| C3 | SR | 10 | 15.3 | 1.5 | 10.5 |
| C4 | SR | 17 | 14 | 1.25 | 18.7 |
| C5 | SR | 25 | 14 | 1.25 | 26.4 |
| C6 | SR | 17 | 12.5 | 1.0 | 19.7 |
| C7 | SR | 17 | 11.2 | 0.8 | 20.9 |
| C8 | SR | 26 | 14 | 1.25 | 26.4 |
| C9 | SR | 24 | 14 | 1.25 | 23.8 |
| C10 | SR | 18 | 14 | 1.25 | 18.5 |
| C11 | SR | 21 | 16 | 1.62 | 18.5 |
| C12 | SR | 26 | 16 | 1.62 | 23.8 |
| C13 | SR | 21 | 13 | 1.07 | 21.7 |
| C14 | SR | 18 | 13 | 1.07 | 18.8 |
| C15 | SR | 17 | 13 | 1.07 | 16.4 |
| C16 | HR | 25 | — | 1.25 | 33.3 |
| C17 | HR | 17 | — | 1.25 | 26.0 |
| C18 | HR | 10 | — | 1.25 | 16.3 |
| C19 | TRI | 25 | — | 1.25 | 41.8 |
| C20 | TRI | 17 | — | 1.25 | 34.0 |
| C21 | TRI | 10 | — | 1.25 | 21.6 |

TABLE 2
Comparative Mechanical Properties

| | | | | Maximum CD |
|---|---|---|---|---|
| | | Basis | Fiber | Tensile |
| | | Weight | Denier | Strength |
| No. | Shape | (gsm) | (dpf) | (g/in) |
| C22 | SR | 25 | 1.5 | 1370 |
| C23 | SR | 25 | 1.25 | 1590 |
| C24 | SR | 17 | 1.5 | 1170 |
| C25 | SR | 17 | 1.25 | 1045 |
| C26 | SR | 17 | 0.8 | 950 |
| C27 | SR | 10 | 1.5 | 530 |
| C28 | HR | 25 | 1.25 | 2040 |
| C29 | HR | 17 | 1.25 | 1310 |
| C30 | HR | 10 | 1.25 | 630 |
| C31 | TRI | 25 | 1.25 | 810 |
| C32 | TRI | 17 | 1.25 | 760 |
| C33 | TRI | 10 | 1.25 | 470 |

### EXAMPLES

### Example 1

### Fibrous Web Containing Mixture of Hollow Round Solid Round and Trilobal Opacity and Mechanical Properties

A polypropylene spunbond fabric is produced using solid round (SR), hollow round (HR) and trilobal fibers (TRI) made from Basell PH-835. A special spinneret is used that contains a mixture of fiber shapes and a metering plate to feed polymer to each orifice. The through-put per holes is 0.4 ghm using 2016 hole spinneret. The fibers are attenuated to an average fiber diameter or denier indicated in the table. The fibers are thermally bonded together using heat and pressure. The following nonwoven fabrics are produced, basis weight determined, and the opacity and/or CD tensile strength of the nonwoven is measured on the samples.

TABLE 3
Examples of shaped fiber web and opacity and mechanical properties

| Basis | | | | Fiber Denier | | | | Maximum |
|---|---|---|---|---|---|---|---|---|
| Weight | Fiber Ratio | | | (dpf) | | | Opacity | CD Strength |
| (gsm) | SR | HR | TRI | SR | HR | TRI | (%) | (g/in) |
| 25 | 80 | 10 | 10 | 1.25 | 1.25 | 1.25 | 28.6 | 1560 |
| 25 | 60 | 20 | 20 | 1.25 | 1.25 | 1.25 | 30.9 | 1520 |
| 25 | 40 | 30 | 30 | 1.25 | 1.25 | 1.25 | 33.1 | 1500 |
| 25 | 20 | 40 | 40 | 1.25 | 1.25 | 1.25 | 35.3 | 1460 |
| 25 | 10 | 45 | 45 | 1.25 | 1.25 | 1.25 | 36.4 | 1450 |
| 17 | 80 | 10 | 10 | 1.25 | 1.25 | 1.25 | 21.0 | 1040 |
| 17 | 60 | 20 | 20 | 1.25 | 1.25 | 1.25 | 23.2 | 1040 |
| 17 | 40 | 30 | 30 | 1.25 | 1.25 | 1.25 | 25.5 | 1040 |
| 17 | 20 | 40 | 40 | 1.25 | 1.25 | 1.25 | 27.7 | 1040 |
| 17 | 10 | 45 | 45 | 1.25 | 1.25 | 1.25 | 28.9 | 1040 |
| 10 | 80 | 10 | 10 | 1.25 | 1.25 | 1.25 | 11.0 | 510 |
| 10 | 60 | 20 | 20 | 1.25 | 1.25 | 1.25 | 13.0 | 520 |
| 10 | 40 | 30 | 30 | 1.25 | 1.25 | 1.25 | 15.0 | 530 |
| 10 | 20 | 40 | 40 | 1.25 | 1.25 | 1.25 | 17.0 | 540 |
| 10 | 10 | 45 | 45 | 1.25 | 1.25 | 1.25 | 18.0 | 545 |
| 25 | 90 | 0 | 10 | 1.25 | — | 1.25 | 27.9 | 1510 |
| 25 | 50 | 0 | 50 | 1.25 | — | 1.25 | 34.1 | 1200 |
| 25 | 10 | 0 | 90 | 1.25 | — | 1.25 | 40.3 | 900 |
| 17 | 90 | 0 | 10 | 1.25 | — | 1.25 | 32.5 | 790 |
| 17 | 50 | 0 | 50 | 1.25 | — | 1.25 | 26.4 | 900 |
| 17 | 10 | 0 | 90 | 1.25 | — | 1.25 | 20.2 | 1020 |
| 10 | 90 | 0 | 10 | 1.25 | — | 1.25 | 10.3 | 490 |
| 10 | 50 | 0 | 50 | 1.25 | — | 1.25 | 15.3 | 490 |
| 10 | 10 | 0 | 90 | 1.25 | — | 1.25 | 20.3 | 470 |
| 25 | 0 | 90 | 10 | — | 1.25 | 1.25 | 34.2 | 1920 |
| 25 | 0 | 50 | 50 | — | 1.25 | 1.25 | 37.6 | 1425 |
| 25 | 0 | 10 | 90 | — | 1.25 | 1.25 | 41.0 | 930 |
| 17 | 0 | 90 | 10 | — | 1.25 | 1.25 | 26.8 | 1255 |
| 17 | 0 | 50 | 50 | — | 1.25 | 1.25 | 30.0 | 1033 |
| 17 | 0 | 10 | 90 | — | 1.25 | 1.25 | 33.2 | 815 |
| 10 | 0 | 90 | 10 | — | 1.25 | 1.25 | 16.8 | 610 |
| 10 | 0 | 50 | 50 | — | 1.25 | 1.25 | 19.0 | 550 |
| 10 | 0 | 10 | 90 | — | 1.25 | 1.25 | 21.1 | 490 |
| 25 | 90 | 10 | 0 | 1.25 | 1.25 | — | 27.1 | 1630 |
| 25 | 50 | 50 | 0 | 1.25 | 1.25 | — | 29.9 | 1815 |
| 25 | 10 | 90 | 0 | 1.25 | 1.25 | — | 32.6 | 1995 |
| 17 | 90 | 10 | 0 | 1.25 | 1.25 | — | 19.4 | 1070 |
| 17 | 50 | 50 | 0 | 1.25 | 1.25 | — | 22.4 | 1180 |
| 17 | 10 | 90 | 0 | 1.25 | 1.25 | — | 25.3 | 1280 |
| 10 | 90 | 10 | 0 | 1.25 | 1.25 | — | 9.7 | 510 |
| 10 | 50 | 50 | 0 | 1.25 | 1.25 | — | 12.7 | 670 |
| 10 | 10 | 90 | 0 | 1.25 | 1.25 | — | 15.6 | 620 |

### Example 2

### Fibrous Webs Containing Two Polymers and Two Shapes

A spunbond machine is set-up to run polypropylene at 220° C. or polyester at 290° C. A spinneret as shown in FIG. 6 may be used to produce the fibers. A metering system with two melt pumps may be used to control each polymer type and melt flow. Nonwovens can be produced at a range of mass flow ratios and deniers. Any combination of polymers and shapes may be used. For example, Basell PH-835 solid round fibers may be combined with Dow Aspun 6811A and/or Eastman F61HC trilobal fibers. Alternatively, the Basell PH-835 could be used to make trilobal fibers and hollow round fibers made of ATOFINA 3860X.

### Example 3

### Fibrous Webs Containing Two Polymers and Two Shapes and a Meltblown Layer

The fibrous fabric of Example 2 is made and combined with a polypropylene meltblown layer made from Exxon 3546G. The average meltblown diameter is 3 microns at a through-put of 0.6 ghm. The two layers can be thermally bonded together or hydroentangled or combined with other bonding methods.

### Example 4

### Fibrous Webs Containing One Polymer and Two Shapes

A fibrous web is produced with solid round meltblown diameter fibers supplied at 0.15 ghm and trilobal spunlaid diameter fiber supplied at 0.4 ghm. In another embodiment, a solid round spunlaid diameter fiber is also produced in the same layer to create a three-fiber layer.

### Example 5

### Fibrous Web Containing a Mixture of Multicomponent Solid Round and Multicomponent Trilobal Fibers

A spunbond nonwoven is produced containing a 50/50 weight percent mixture of multicomponent solid round and multicomponent trilobal fibers. The multicomponent solid round fibers are sheath and core with a 50/50 weight percent ratio of ATOFINA 3860X as the sheath material and Basell Profax PH-835 as the core. The solid round fibers are attenuated to a range of diameters down to 1.0 dpf, depending on the mass throughput per capillary. The trilobal fibers are composed of a 20/80 weight percent ratio of ATOFINA as the trilobal tip material and Basell Profax PH-835 as the core. The trilobal fibers are attenuated to a range of diameters down to 1.0 dpf, depending on the mass throughput per capillary. These fibers are then consolidated together using conventional bonding methods, most commonly thermal point bonding, but hydroentangling can also be used. Basis weight down to 5 gsm can be produced. If desired, a polypropylene meltblown layer can be produced using Exxon 3546G. The average meltblown diameter is 3 microns at a through-put of 0.6 ghm. The meltblown layer is then combined with the spunlaid layer either by direct collection or brought in from a second source. Other alternate layers can be added. The fibers are thermally bonded together using heat and pressure. This nonwoven has high opacity characteristics with improved strength due to the presence of the lower molecular weight ATOFINA 3860X outer component of the multicomponent fibers. The component ratio of individual fibers can be changed to further adjust the strength and the ratio of shaped fibers can be changed to alter the opacity and strength, as needed for a desired application.

### Example 6

### Fibrous Web Containing a Mixture of Multicomponent Solid Round and Multicomponent Trilobal Fibers Plus Mixed Meltblown Diameter

A spunbond nonwoven is produced containing a 45/45/10 weight percent mixture of multicomponent solid round, multicomponent trilobal fibers, and meltblown diameter fibers. The multicomponent solid round fibers are sheath and core with a 50/50 weight percent ratio of ATOFINA 3860X as the sheath material and Basell Profax PH-835 as the core. The solid round fibers are attenuated to a range of diameters down to 1.0 dpf, depending on the mass throughput per capillary. The trilobal fibers are composed of a 20/80 weight percent ratio of ATOFINA as the trilobal tip material and Basell Profax PH-835 as the core. The trilobal fibers are attenuated to a range of diameters down to 1.0 dpf, depending on the mass throughput per capillary. The solid round and trilobal spunbond orifice are supplied a polymer at 0.4 ghm, while the meltblown diameter orifices are supplied polymer at 0.15 ghm. All of these fibers are extruded from an etched metering plate and spinneret. The meltblown diameter fibers have an average diameter of 6 microns. These fibers are then consolidated together using conventional bonding methods. This nonwoven also has high opacity characteristics with improved strength due to the presence of the lower molecular weight ATOFINA 3860X outer component of the multicomponent fibers. The component ratio in individual fibers can be changed to further adjust the strength and the ratio of shaped fibers can be changed to alter the opacity and strength, as needed for a desired application.

### Example 7

### Fibrous Web Containing a Mixture of Multicomponent Solid Round, Monocomponent Trilobal Fibers, and Meltblown Diameter Fibers

A spunbond nonwoven is produced containing a 20/70/10 weight percent mixture of multicomponent solid round, monocomponent trilobal fibers and meltblown diameter fibers. The multicomponent solid round fibers are a 75/25 weight percent ratio of Eastman F61HC polyester as the core material and Eastman 14285 as the sheath material. The multicomponent round fibers are attenuated to a range of diameters down to 1.0 dpf, depending on the mass throughput per capillary. The monocomponent trilobal fibers are composed of Eastman F61HC. The polyester meltblown fibers are produced using an Eastman F33HC. The monocomponent trilobal fibers are attenuated to a range of sizes down to 1.0 dpf, depending on the mass throughput per capillary. The average meltblown diameter is 3 microns at a through-put of 0.6 ghm. This construction is used to produce a high strength and loft polyester spunbond. The component ratio in individual fibers and between fiber types can be changed to further alter the opacity and strength, as needed for a desired application.

### Example 8

### Fibrous Web Containing a Mixture of Multicomponent Solid Round and Monocomponent Trilobal Fibers

A spunbond nonwoven is produced containing a 20/70/10 weight percent mixture of multicomponent solid round, monocomponent trilobal fibers and meltblown diameter fibers from the same spinneret. Alternatively, a spunbond nonwoven can be produced containing a 30/70 weight percent mixture of multicomponent solid round and monocomponent trilobal fibers. The multicomponent solid round fibers are a 75/25 weight percent ratio of Eastman F61 HC polyester as the core material and Eastman 14285 as the sheath material. The multicomponent round fibers are attenuated to a range of diameters down to 1.0 dpf, depending on the mass throughput per capillary. The monocomponent trilobal fibers are composed of Eastman F61HC. If present, the polyester meltblown fibers are produced using an Eastman F33HC. The monocomponent trilobal fibers are attenuated to a range of sizes down to 1.0 dpf, depending on the mass throughput per capillary. The average meltblown diameter is 6 microns at a through-put of 0.15 ghm. The nonwoven web with shaped fibers may be combined with a meltblown layer. Other alternate layers can be added.

Many examples have been shown and given here to demonstrate the breadth of fibers that can be produced to illustrate the invention. Although not limited by the data presented in this invention, further variations are known.

The disclosures of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

While particular embodiments of the present invention have been illustrated and described, it would be obvious to those skilled in the art that various other changes and modifications can be made without departing from the spirit and scope of the invention.

It is intended to cover in the appended claims all such changes and modifications that are within the scope of the invention.

1. A spunmelt fibrous fabric comprising at least one layer comprising a mixture of shaped fibers having cross-sectional shapes distinct from one another.

2. The fibrous fabric of claim 1 wherein the cross-sectional shapes of the shaped fibers are selected from the group consisting of solid round fibers, hollow round fibers, multi-lobal solid fibers, hollow multi-lobal fibers, crescent shaped fibers, square shaped fibers, crescent shaped fibers, and any combination thereof.

3. The fibrous fabric of claim 1 wherein each shaped fiber has a different diameter.

4. The fibrous fabric of claim 1 wherein each shaped fiber has the same denier.

5. The fibrous fabric of claim 4 wherein at least one of the shaped fibers has a spunlaid diameter.

6. The fibrous fabric of claim 5 wherein at least two of the shaped fibers has a spunlaid diameter.

7. The fibrous fabric of claim 5 wherein at least one of the shaped fibers has a meltblown diameter.

8. The fibrous fabric of claim 6 wherein at least one of the shaped fibers has a meltblown diameter.

9. The fibrous fabric of claim 1 wherein each shaped fiber is comprised of a different polymer.

10. The fibrous fabric of claim 1 wherein at least one of the shaped fibers is a bicomponent fiber.

11. The fibrous fabric of claim 1 wherein one of the fibers is a solid round and one of the fibers is a trilobal.

12. The fibrous fabric of claim 1 wherein each of the two of more shaped fibers comprises from about 10% to about 90% of the total shaped fibers.

13. The fibrous fabric of claim 11 wherein the solid round fibers comprise about 25% and the trilobal fibers comprise about 75% of the total shaped fibers.

14. The fibrous fabric of claim 4 wherein an apparent bulk density of the layers comprising shaped fibers is from about 2% to about 50% lower than the bulk density of a layer comprising substantially all solid round fibers.

15. The fibrous fabric of claim 1 where the shaped fibers are produced from at least one spunlaid process comprising a spinpack comprising at least one polymer metering plate and spinneret.

16. The fibrous fabric of claim 1 wherein the shaped fibers are produced from a single spinneret.

17. A nonwoven laminate comprising at least one first spunmelt layer comprising a mixture of shaped fibers having two or more different cross sections and at least one second layer comprising different fibers.

18. The nonwoven laminate of claim 17 wherein the second layer is selected from the group consisting of spunmelt such as meltblown or spunbond, a nanofiber, carded, wet laid, cellulosic, film, and combinations thereof.

19. The nonwoven laminate of claim 18 wherein the second layer is a meltblown layer.

20. The nonwoven laminate of claim 17 comprising two first layers laminated on either side of a meltblown layer.

21. A disposable article containing a spunmelt nonwoven fibrous fabric comprising at least one layer comprising a mixture of shaped fibers having two or more different cross sections.

22. The disposable article of claim 17 wherein the article is selected from the group consisting of a diaper, a catamenial, and a wipe.

23. The disposable article of claim 18 containing a spunmelt nonwoven fibrous fabric wherein the article is a diaper and the fibrous fabric is utilized as a topsheet, backsheet, outer cover, leg cuff, ear, side panel covering, dusting layer, acquisition layer, core wrap, core, or combinations thereof.
